(19) United States
(12) Patent Application Publication
(10) Pub. No.: US 2009/0039177 A1
(43) Pub. Date: Feb. 12, 2009

(54) Spray device for a hair shine composition

(76) Inventor: Francois Le Bourhis, Aubervilliers (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/071,621

(22) Filed: Feb. 25, 2008

Related U.S. Application Data
(60) Provisional application No. 60/907,402, filed on Mar. 30, 2007.

(30) Foreign Application Priority Data
Feb. 23, 2007 (FR) 0753480

(51) Int. Cl. B05B 1/08; B05B 1/14

(52) U.S. Cl. 239/102.2; 239/548

(57) ABSTRACT

The present disclosure relates to a spraying device for a cosmetic composition comprising a container provided with a spraying mechanism comprising:
a perforated membrane, the membrane perforations making the container inner space communicate with the external environment,
an actuator for vibrating the membrane,
a mechanism for making the liquid cosmetic composition contained in the container contact an inner surface of the membrane,
wherein the cosmetic composition, under the effect of the membrane vibrations, flows through the perforations until reaching an outer surface of the membrane from which it emerges as droplets, and the liquid cosmetic composition comprising, in a cosmetically acceptable medium, at least one silicone, and/or at least one non silicone fatty substance.

This application claims benefit of U.S. Provisional Application No. 60/907,402, filed Mar. 30, 2007, the contents of which are incorporated herein by reference. This application also claims benefit of priority under 35 U.S.C. § 119 to French Patent Application No. FR 0753480, filed Feb. 23, 2007, the contents of which are also incorporated herein by reference.

The present disclosure relates to a specific spraying device, containing a cosmetic composition which in turn comprises at least one silicone, and/or at least one fatty substance, intended to provide shine to the hair.

Hair shine products conditioned in aerosols, which are currently available on the market, typically comprise a liquid phase comprising at least one hair shine-providing raw material, such as a silicone or a fatty substance, and are propelled by an aerosol-generating, liquefied gas kept under reduced pressure. Such gases do generally comprise volatile organic compounds (VOC).

The new regulations that are being implemented in many countries tend to impose a reduction in the amounts of volatile organic compounds (VOC) that are released in the atmosphere by the aerosol-generating gases.

To aim at such a reduction, a non VOC propellant gas such as HFA 152a may be used to partly or fully act as a substitute for the traditionally used propellant gases. However, using this type of gas is not allowed in all countries.

In the case of a traditional aerosol, another solution for limiting the use of VOC consists in introducing a great amount of water in the cosmetic compositions.

The results, as far as the use quality and the cosmetic efficiency are concerned for cosmetic compositions comprising large amounts of water, are not so satisfying as compared to formulations of the previous art. Water is indeed not compatible with shine providing agents as it affects the hair shine level.

Another way to limit the use of VOC is to go without any gas propellant, for instance by using a spraying device provided with a mechanical pump. Each time the device is actuated, a unit dose of the product is delivered onto the hair. Such delivery discontinuity may result in an uneven distribution of the product over the hair, and may lead to a poor hair shine level.

Surprisingly and unexpectedly, the applicant discovered that using a specific spraying device, comprising a container, the spray nozzle of which has a perforated membrane, actuated by a vibrating system and through which the liquid cosmetic composition is converted into droplets, the vibrating system being, for example, a piezoelectric system, may solve the above mentioned problems when used in conjunction with a cosmetic composition comprising at least one silicone, and/or a non silicone fatty substance. This joint use makes it possible, without using VOC-generating propellant gases, to obtain an excellent hair shine level, as compared to the solutions of the previous art as described hereabove.

Accordingly, one aspect of the present disclosure is a device for spraying a cosmetic composition comprising a container provided with a spraying mechanism comprising:

a perforated membrane, the membrane perforations making the container inner space communicate with the external environment,

an actuator for vibrating the membrane,

a mechanism for making the liquid cosmetic composition contained in the container contact an inner surface of the membrane,

wherein the cosmetic composition, under the effect of the membrane vibrations, flows through the perforations until reaching an outer surface of the membrane from which it emerges as droplets, and
wherein said liquid cosmetic composition comprising, in a cosmetically acceptable medium, at least one silicone, and/or at least one non silicone fatty substance.

The perforations in the membrane may have a reverse taper, that it to say a cross-sectional area that is larger on the outer surface of the membrane facing the external environment, than on the inner surface, facing the interior of the container.

Moreover, the spraying device may comprise a pressure bias method, such as described in Application Publication No. WO95/15822, providing a reduced pressure to the liquid contacting the inner surface of the membrane. The reduced pressure may vary from ambient pressure to the pressure at which the air is sucked-in through the perforations of the membrane contacting the composition.

According to at least one embodiment, the perforations on the outer surface of the membrane do not contact each other.

According to another embodiment, the actuator is a piezoelectric actuator, conceived for example for making the membrane vibrate in a frequency ranging from 20 KHz to 7 MHz. The energy necessary for the piezoelectric actuator to run may be obtained with the assistance of an electric generator, for example an electric cell, a battery or a photovoltaic cell that might be optionally coupled with an electronic circuit.

In the hereabove defined spraying mechanism, said mechanism for conveying the liquid cosmetic composition to the surface of the membrane may comprise a capillary-based feeding mechanism, or as an alternative, a bubble generator-based feeding mechanism. Such mechanisms are described, for example, in Patent Application Publication No. WO 95/15822.

In the embodiments of the present disclosure, as disclosed herein, all the perforations can have a reverse taper, or on the contrary, the membrane is in addition provided with normally tapered perforations.

As used herein, a “normally tapered perforation” is understood to mean a perforation which cross-sectional area is smaller on the outer surface of the membrane facing the external environment, than on the inner surface, facing the interior of the container.

When normally tapered perforations are present, these are arranged, for example, all around and on the outside of the reverse tapered perforations.

The mechanism for conveying the liquid cosmetic composition to the surface of the membrane may be designed so as to convey said composition to the inner surface of said membrane, or on the contrary, be designed so as to convey said composition to the outer surface of said membrane. Such alternative versions of the spraying device are described, for example, in the Patent Application Publication No. WO 95/15822.

As a non-limiting illustration, the membrane may be designed as a circular plate of 8 mm diameter, in electroformed nickel, with a 70 μm thickness and having a plurality of perforations. The perforations may have a cross-sectional area in the form of a circular plate which diameter ranges from 4 to 150 μm on the outer surface of the membrane facing the external environment, and on the inner surface facing the inside of the container, a cross-sectional area in the form of a circular plate which diameter ranges from 2 to 50 μm, and for example from 10 to 20 μm.

When using the device, the cosmetic composition is dispensed as droplets which can have a mean diameter ranging from 20 to 100 μm, and even, for example, from 30 to 60 μm.

The silicones to be suitably used in the cosmetic compositions of the present disclosure include, for example, volatile or non volatile, cyclic, linear or branched silicones, for instance, those that have been modified or not with organic groups, or aryl silicones, and according to at least one embodiment, having a viscosity ranging from 5.10⁻⁶ to 2,5 m²/s at 25° C. and further, for example, from 1.10⁻⁵ to 1 m²/s.

The silicones to be suitably used according to the present disclosure may be present in a form which is soluble in, dispersed, micro- or nanodispersed within the composition, and according to at least one embodiment, may be polyorganosiloxanes insoluble in the composition of the present disclosure. They may present in the form of oils, waxes, resins or gums.

Organopolysiloxanes are defined in more detail by Walter NOLL in “Chemistry and Technology of Silicones” (1968), Academie Press. They may be volatile or not.

When they are volatile, the at least one silicone may be chosen from those having a boiling point ranging from 60° C. to 260° C., for instance, the at least one silicone may be chosen from:

(i) cyclic polydialkyl siloxanes comprising from 3 to 7, for example from 4 or 5 silicon atoms. Suitable examples thereof include, but are not limited to, octamethyl cyclotetrasiloxane marketed under the trade name “VOLATILE SILICONE® 7207” by UNION CARBIDE or “SILBIONE® 70045 V2” by RHODIA, decamethyl cyclopentasiloxane marketed under the trade name “VOLATILE SILICONE® 7158” by UNION CARBIDE, “SILBIONE® 70045 V5” by RHODIA, as well as mixtures thereof.

Cyclocopolymers of the dimethyl siloxane and methylalkyl siloxane type may also be mentioned, such as “SILICONE VOLATILE® FZ 3109” marketed by the UNION CARBIDE company, having the following formula:

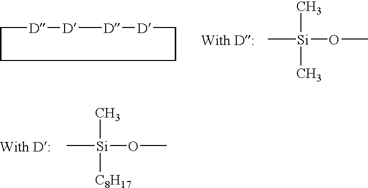

Mixtures of cyclic polydialkyl siloxanes with organic compounds derived from silicon may also be mentioned, such as the octamethyl cyclotetrasiloxane and tetratrimethylsilyl pentaerythritol mixture (50:50) and the octamethyl cyclotetrasiloxane and oxy-1,1′-(hexa-2,2,2′,2′,3,3′-trimethylsilyloxy) bis-neopentane mixture;

(ii) linear volatile polydialkyl siloxanes having from 2 to 9 silicon atoms, and a viscosity lower than or equal to 5.10⁻⁶ m²/s at 25° C., as for example decamethyl tetrasiloxane marketed for instance under the trade name “SH 200” by the TORAY SILICONE company. Silicones belonging to this class are also described in the article published in Cosmetics and Toiletries, Vol. 91, January 1976, pp. 27-32—TODD & BYERS “Volatile Silicone fluids for cosmetics”.

Non volatile polydialkyl siloxanes may be used, as well as polydialkyl siloxane gums and resins, polyorganosiloxanes modified with the previously mentioned organofunctional groups, as well as mixtures thereof.

These silicones may be chosen from polydialkyl siloxanes, from which, for instance, polydimethyl siloxanes with trimethylsilyl end groups may be mentioned. Silicone viscosity is measured at 25° C., according to ASTM 445 standard, Appendix C.

These polydialkyl siloxanes may encompass, as non-limiting examples, the following commercial products:
SILBIONE® oils of 47 and 70 047 series or MIRASIL® oils marketed by RHODIA, such as, for example, oil 70 047 V 500 000;
oils of MIRASIL® series marketed by the RHODIA company;
oils of 200 series from the DOW CORNING company, such as DC200 (viscosity 60 000 mm²/s); and
VISCASIL® oils from GENERAL ELECTRIC and some oils of SF (SF 96, SF 18) series from GENERAL ELECTRIC.

Dimethylsilanol end group-containing polydimethyl siloxanes, known under the name dimethiconol (CTFA) may also be mentioned in a non-limiting manner, such as oils of 48 series from the RHODIA company.

This polydialkyl siloxane class also includes products marketed under the trade names “ABIL WAX® 9800 and 9801” by the GOLDSCHMIDT company, which are (C₁-C₂₀) polydialkyl siloxanes.

Silicone gums suitable for use according to the present disclosure include, for instance, polydialkyl siloxanes, such as polydimethyl siloxanes having high number average molecular weights ranging from 200,000 to 1,000,000 used either alone or in combination in a solvent. This solvent may be selected from volatile silicones, polydimethyl siloxane (PDMS) oils, polyphenylmethyl siloxane (PPMS) oils, isoparaffins, polyisobutylenes, methylene chloride, pentane, dodecane, tridecane and mixtures thereof.

The following mixtures are products which may also be suitably used according to the present disclosure:

mixtures formed from an end chain-hydroxylated polydimethyl siloxane (also called dimethiconol, CTFA) and a cyclic polydimethyl siloxane, also called cyclomethicone (CTFA), such as the Q2 1401 product marketed by the DOW CORNING company;

mixtures formed from a polydimethyl siloxane gum and a cyclic silicone, such as the SF 1214 Silicone Fluid from the GENERAL ELECTRIC company, this product being a SF 30 gum corresponding to a dimethicone, having a number average molecular weight of 500,000, solubilized in the SF 1202 Silicone Fluid corresponding to decamethyl cyclopentasiloxane;

mixtures from two PDMS with different viscosities, for example, from a PDMS gum and a PDMS oil, such as the SF 1236 product from GENERAL ELECTRIC. SF 1236 is a mixture from a SE 30 gum as defined hereabove with a viscosity of 20 m²/s and a SF 96 oil with a viscosity of 5.10⁻⁶ m²/s. Such product comprises, for example, 15% of SE 30 gum and 85% of SF 96 oil.

Organopolysiloxane resins to be used according to the present disclosure are crosslinked siloxane systems comprising R₂SiO_{2/2}, R₃SiO_{1/2}, RSiO_{3/2} and SiO_{4/2} units, wherein R is an alkyl group having from 1 to 16 carbon atom(s). Among these products, those that are used according to at least one embodiment, include those wherein R is a lower C₁-C₄ alkyl group, such as a methyl group.

These resins also include the product marketed under the trade name “DOW CORNING 593” or those marketed under the trade names “SILICONE FLUID SS 4230 and SS 4267” by the GENERAL ELECTRIC company and which are dimethyl/trimethyl siloxane-structured silicones.

Resins of the trimethyl siloxysilicate type marketed, for example, under the trade names X22-4914, X21-5034 and X21-5037 by the SHIN-ETSU company may also be mentioned.

Organomodified silicones to be suitably used according to the present disclosure include silicones such as those previously defined, and comprising in their structure at least one organofunctional group bound through a hydrocarbon group.

In addition to the hereabove silicones, said organomodified silicones may be polydiaryl siloxanes, where according to at least one embodiment, polydiphenyl siloxanes, and polyalkylaryl siloxanes functionalized with the organofunctional groups as previously mentioned are used.

According to another embodiment, polyalkylaryl siloxanes can be used and are chosen from linear and/or branched, polydimethyl methylphenyl siloxanes and polydimethyl diphenyl siloxanes, with a viscosity ranging from 1.10⁻⁵ to 5.10⁻² m²/s at 25° C.

Suitable examples of such polyalkylaryl siloxanes include the products marketed under the following trade names:
SILBIONE® oils of 70 641 series from RHODIA;
oils of RHODORSIL® 70 633 and 763 series from RHODIA;
a phenyl trimethylsiloxy trisiloxane, for instance the DOW CORNING 556 COSMETIC GRAD FLUID oil from DOW CORNING;
silicones of PK series from BAYER, such as the PK20 product;
silicones of PN, PH series from BAYER, such as PN1000 and PH1000 products; and
some oils of SF series from GENERAL ELECTRIC, such as SF 1023, SF 1154, SF 1250, SF 1265.

Organomodified silicones suitable for use herein include polyorganosiloxanes comprising:

polyethyleneoxy and/or polypropyleneoxy groups optionally comprising C₆-C₂₄ alkyl groups, such as products called dimethicone copolyol marketed by the DOW CORNING company under the trade name DC 1248 or SILWET® L 722, L 7500, L 77, L 711 oils from the UNION CARBIDE company and (C₁₂)alkyl methicone copolyol marketed by the DOW CORNING company under the trade name Q2 5200;

amine groups, substituted or not, such as the products marketed under the trade name GP 4 Silicone Fluid and GP 7100 by the GENESEE company, or the products marketed under the trade names Q2 8220 and DOW CORNING 929 or 939 by the DOW CORNING company. Substituted amine groups include, for example, C₁-C₄ aminoalkyl groups.

alkoxylated groups, such as the product marketed under the trade name “SILICONE COPOLYMER F-755” by SWS SILICONES and ABIL WAX® 2428, 2434 and 2440 by the GOLDSCHMIDT company.

According to one embodiment, the at least one silicone of the present disclosure is chosen from volatile, linear and cyclic polydimethyl siloxanes.

According to another embodiment, the at least one silicone is chosen from phenyl silicones.

The silicones such as described hereabove may be used either alone or in combinations, in an amount ranging from 0.1 to 40% by weight, for instance from 1 to 20% by weight relative to the total weight of the composition.

As used herein, a “non silicone fatty substance” is understood to mean a compound chosen from a fatty alcohol, a fatty ester, a mineral, vegetable, animal or synthetic oil, or a wax.

Non silicone oils to be suitably used in the composition of the present disclosure include, for example:

hydrocarbon-based animal oils, such as perhydrosqualene;

hydrocarbon-based vegetable oils, such as fatty acid liquid triglycerides having from 4 to 10 carbon atoms such as heptanoic or octanoic acid triglycerides or, for example sunflower seed, corn, soja bean, pumpkin, grape seed, sesame, hazelnut, apricot kernel, macadamia, arara, castor and avocado oils, caprylic/capric acid triglycerides such as those marketed by the Stearineries Dubois company or those marketed under the trade names Miglyol® 810, 812 and 818 by the Dynamit Nobel company, jojoba oil, or shea butter oil;

synthetic or mineral linear or branched hydrocarbons, such as volatile or non volatile paraffin oils, and derivatives thereof, petrolatum, liquid petrolatum, polydecenes, hydrogenated polyisobutene such as Parleam®; isoparaffins like isohexadecane and isodecane.

partly hydrocarbon-based and/or silicone-based fluorinated oils, such as those described in the Application No. JP-A-2-295912; fluorinated oils also encompass perfluoromethyl cyclopentane and perfluoro-1,3 dimethylcyclohexane, sold under the names “FLUTEC® PC1” and “FLUTEC® PC3” by the BNFL Fluorochemicals company; perfluoro-1,2-dimethyl cyclobutane; perfluoroalkanes such as dodecafluoropentane and tetradecafluorohexane, sold under the names “PF 5050®” and “PF 5060®” by the 3M company, or bromoperfluorooctyl sold under the trade name “FORALKYL®” by the Atochem company; nonafluoromethoxybutane and nonafluoroethoxyisobutane; perfluoromorpholine derivatives, such as 4-trifluoromethyl perfluoromorpholine sold under the trade name “PF 5052®” by the 3M company;

The at least one fatty alcohol can be chosen from linear and branched, saturated and unsaturated fatty alcohols having from 8 to 26 carbon atoms, such as ethyl alcohol, stearyl alcohol and mixtures thereof (cetylstearyl alcohol), octyldodecanol, 2-butyloctanol, 2-hexyldecanol, 2-undecylpentadecanol, oleyl alcohol or linoleic alcohol;

The at least one wax can be chosen from Carnauba wax, Candellila wax, and Alfa wax, paraffin, ozokerite, vegetable waxes such as olive tree wax, rice wax, hydrogenated jojoba wax or flower absolute waxes such as Ribes nigrum (blackcurrant) flower wax sold by the BERTIN company (France), animal waxes such as beeswax, or modified beeswaxes (cerabellina); other waxes or wax-based raw materials to be used according to the present disclosure include marine waxes, such as the one sold by the SOPHIM company under the reference M82, polyethylene waxes or polyolefins in general.

Fatty esters can be chosen from carboxylic acid esters, for example, mono, di, tri or tetracarboxylic esters.

According to at least one embodiment, monocarboxylic acid esters are chosen from saturated or unsaturated, linear or branched, C₁-C₂₆ aliphatic acid monoesters and saturated or unsaturated, linear or branched, C₁-C₂₆ aliphatic alcohol monoesters, where the total number of the ester carbon atoms is higher or equal to 10.

Suitable examples of such esters to be mentioned include, but are not limited to, dihydroabietyl behenate; octyldodecyl behenate; isocetyl behenate; cetyl lactate; C₁₂-C₁₅ alkyl lactate, isostearyl lactate; lauryl lactate; linoleyl lactate; oleyl lactate; (iso)stearyl octanoate; isocetyl octanoate; octyl octanoate; cetyl octanoate; decyl oleate; isocetyl isostearate; isocetyl laurate; isocetyl stearate; isodecyl octanoate; isodecyl oleate; isononyl isononanoate; isostearyl palmitate; methylacetyl ricinoleate; myristyl stearate; octyl isononanoate; 2-ethylhexyl isononate; octyl palmitate; octyl pelargonate; octyl stearate; octyldodecyl erucate; oleyl erucate; ethyl and isopropyl palmitates, ethyl-2-hexyl palmitate, 2-octyidecyl palmitate, alkyl myristates, such as isopropyl, butyl, cetyl, 2-octyldodecyl myristyl, stearyl myristate, hexyl stearate, butyl stearate, isobutyl stearate; dioctyl malate, hexyl laurate, and 2-hexyldecyl laurate.

C₄-C₂₂ di- or tricarboxylic acid and C₁-C₂₂ alcohol esters may also be used, as well as mono-, di- or tricarboxylic acid esters and di-, tri-, tetra- or pentahydroxy C₂-C₂₆ alcohol esters.

As disclosed herein, mention is made of diethyl sebacate; diisopropyl sebacate; diisopropyl adipate; di n-propyl adipate; dioctyl adipate; diisostearyl adipate; dioctyl maleate; glyceryl undecylenate; octyidodecyl stearoyl stearate; pentaerythrityl monoricinoleate; pentaerythrityl tetraisononanoate; pentaerythrityl tetrapelargonate; pentaerythrityl tetraisostearate; pentaerythrityl tetraoctanoate; propylene glycol dicaprylate; propylene glycol dicaprate; tridecyl erucate; triisopropyl citrate; triisostearyl citrate; glyceryl trilactate; glyceryl trioctanoate; trioctyldodecyl citrate; trioleyl citrate.

Amongst the previously mentioned esters, according to at least one embodiment, the esters are chosen from ethyl, isopropyl, myristyl, cetyl and stearyl palmitates, ethyl-2-hexyl palmitate, 2-octyldecyl palmitate, alkyl myristates, such as isopropyl, butyl, cetyl, 2-octyldodecyl myristate, hexyl stearate, butyl stearate, isobutyl stearate; dioctyl malate, hexyl laurate, 2-hexyldecyl laurate and isononyl isononanoate, cetyl octanoate.

In one embodiment, among the non silicone fatty substances, liquid petrolatum or a monocarboxylic acid ester will be used, for instance.

The at least one non silicone fatty substance may be present in an amount ranging from 0.1 to 40% by weight, for example, from 1 to 20% by weight, relative to the total weight of the cosmetic composition.

The previously described cosmetic compositions may also further comprise at least one cosmetically acceptable adjuvant, such as, for example, fixing polymers, surfactants, thickeners, penetrating agents, fragrances, peptizing agents, buffers, and various traditional additives such as sunscreen agents, preserving agents, ceramides, pseudoceramides, vitamins or provitamins, such as panthenol, reducing agents, emulsifying agents, fillers, sunscreens, proteins, moisturizing agents, emollients, softening agents, anti-foam agents, anti-free radical agents, bactericides, sequestering agents, anti-dandruff agents, antioxidants, alkalinizing agents, polyols and any other adjuvant traditionally used in cosmetic compositions intended to be applied onto the hair.

As used herein, a “fixing polymer” is understood to mean any polymer that may provide the hair with a shape and/or that may be able to retain its shape.

In the present disclosure, any fixing polymer known as such in the field of hair care may be used, as well as mixtures comprising several of such polymers. Traditionally, a difference is made between cationic, anionic, amphoteric and non ionic fixing polymers.

Cationic fixing polymers that may be used according to the present disclosure can be chosen from polymers having primary, secondary, tertiary and/or quaternary amine groups making part of the polymer chain or directly bound to it, and having a molecular weight ranging from 500 to 5,000,000 and further, for example, from 1,000 to 3,000,000.

By way of non-limiting example, among these polymers are the following cationic polymers:

(1) homopolymers or copolymers derived from acrylic or methacrylic esters or amides and having at least one of the following units:

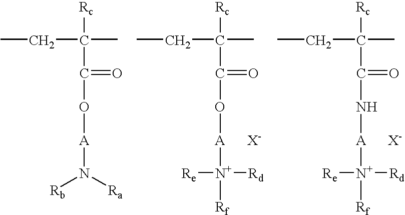

wherein:

Rₐ and R_{b} are a hydrogen atom or a C₁₋₆ alkyl group,

R_{c} is a hydrogen atom or a CH₃ radical,

R_{d}, Rₑ and R_{f}, being the same or different, are chosen from C₁₋₁₈ alkyl groups and benzyl radicals,

A is chosen from linear and branched C₁₋₆ alkyl groups and C₁₋₄ hydroxyalkyl groups, and

X⁻ is a methosulfate or halide anion such as a chloride or bromide ion.

Copolymers of family (1) comprise moreover at least one unit derived from comonomers that may be chosen from the family including acrylamides, methacrylamides, diacetone-acrylamides, acrylamides and methacrylamides substituted on the nitrogen atom with lower alkyl groups, acrylic or methacrylic acids or esters thereof, vinyl lactams such as vinyl pyrrolidone or vinyl caprolactam, and vinyl esters.

Thus, the following copolymers of family (1) may be mentioned in a non-limiting manner:
copolymers of acrylamide and dimethylaminoethyl methacrylate quaternized with dimethyl sulfate or with a dimethyl halide, such as the one marketed under the trade name HERCOFLOC® by the HERCULES company,
copolymers of acrylamide and methacryloyl-oxyethyl trimethylammonium chloride described for example in the European patent application EP-A-080976 and marketed under the trade name BINA QUAT® P 100 by the CIBA GEIGY company,
the copolymer of acrylamide and methacryloyloxyethyl trimethylammonium methosulfate marketed under the trade name RETEN® by the HERCULES company,
copolymers of vinyl pyrrolidone and dialkylaminoalkyl acrylate or methacrylate quaternized or not, such as the products marketed under the trade name GAFQUAT® by the ISP company, as for example GAFQUAT® 734 or GAFQUAT® 755, or the so called COPOLYMER® 845, 958 and 937 products. These polymers are described in detail in the French patent Application Nos. FR 2 077 143 and FR 2 393 573,
terpolymers of dimethylaminoethyl methacrylate, vinyl caprolactame and vinyl pyrrolidone, such as the product marketed under the trade name GAFFIX VC 713 by the ISP company, and
the copolymer of vinyl pyrrolidone and quaterinzed dimethylaminopropyl methacrylamide, such as the product marketed under the trade name GAFQUAT® HS 100 by the ISP company.

(2) the quaternized polysaccharides such as those described, for example, in U.S. Pat. Nos. 3,589,578 and 4,031,307, such as guar gums comprising trialkylammonium cationic groups.

Such products are marketed, for instance, under the trade names JAGUAR® C13 S, JAGUAR® C15 and JAGUAR® C17 by the MEYHALL company.

(3) Quaternary copolymers of vinyl pyrrolidone and vinyl imidazole such as the products marketed by BASF under the trade name LUVIQUAT® TFC,

(4) chitosans or their salts, including for example, chitosan acetate, lactate, glutamate, gluconate or pyrrolidone carboxylate.

Further non-limiting mention may be made of the chitosan with a desacetylation rate of 90.5% by weight marketed under the trade name KYTAN BRUT STANDARD® by the ABER TECHNOLOGIES company, and chitosan pyrrolidone carboxylate marketed under the trade name KYTAMER® PC by the AMERCHOL company.

(5) Cellulose cationic derivatives such as cellulose copolymers or cellulose derivatives graft with a water-soluble monomer comprising a quaternary ammonium group, described in U.S. Pat. No. 4,131,576 such as hydroxyalkyl celluloses, such as hydroxymethylhydroxyethyl- or hydroxypropyl celluloses graft for instance with a methacryloyloxyethyl trimethylammonium salt, a methacrylamidopropyl trimethylammonium salt or a dimethyl diallylammonium salt.

The marketed products corresponding to such a definition include but are not limited to the products sold under the trade names CELQUAT® L 200 and CELQUAT® H 100 by the NATIONAL STARCH company.

The anionic fixing polymers that are used in general include polymers comprising groups derived from a carboxylic, a sulfonic or a phosphoric acid and have a weight average molecular weight ranging from about 500 to 5,000,000.

The carboxylic acid groups are carried by unsaturated monomers comprising one or two carboxylic acid functional groups, such as those of formula (I):

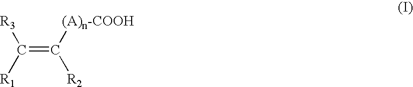

wherein n is an integer ranging from 0 to 10, A is a methylene group, optionally bound to the carbon atom of the unsaturated group or of the adjacent methylene group, when n is higher than 1, through a heteroatom such as oxygen or sulfur, R₃ is chosen from a hydrogen atom, phenyl and benzyl groups, R₁ is a hydrogen atom, a lower alkyl or a carboxyl group, and R₂ is chosen from a hydrogen atom, lower alkyl groups, —CH₂—COOH groups, and phenyl and benzyl groups.

In the above mentioned formula (I), a lower alkyl radical is, for example, a group having from 1 to 4 carbon atom(s), such as a methyl or an ethyl group.

The carboxylated anionic fixing polymers that may be used in the present disclosure include but are not limited to:

A) homo- or copolymers of acrylic or methacrylic acid or their salts, for instance the products marketed under the trade names VERSICOL® E or K by the ALLIED COLLOID company, and under the trade name ULTRAHOLD® by the BASF company; copolymers of acrylic acid and acrylamide marketed in the form of sodium salt under the trade names RETEN® 421, 423 or 425 by the HERCULES company; the sodium salts of polyhydroxycarboxylic acids.

B) Copolymers of acrylic acid or methacrylic acid and of a monoethylene-based monomer such as ethylene, styrene, vinyl esters, acrylic or methacrylic acid esters.

These copolymers may be graft on a polyalkylene glycol such as polyethylene glycol and are optionally crosslinked.

Such polymers are described, for example, in the French Application No. FR 1 222 944 and in the German Application No. DE 2 330 956. Copolymers comprising in their chain an optionally N-alkylated and/or hydroxyalkylated acrylamide unit may be mentioned, such as those described in both patent applications LU 75370 and LU75371 or proposed under the trade name QUADRAMER® by the AMERICAN CYANAMID company.

Copolymers of acrylic acid and C₁-C₄ alkyl methacrylate, and terpolymers of vinyl pyrrolidone, (meth)acrylic acid and C₁-C₂₀ alkyl (meth)acrylate may also be mentioned, for example of lauryl (ACRYLDONE® LM from the ISP company), of tertbutyl (LUVIFLEX® VBM 70 marketed by BASF) or of methyl (STEPANHOLD® EXTRA marketed by STEPAN), and terpolymers of methacrylic acid, ethyl acrylate and tertbutyl acrylate such as the product marketed under the trade name LUVIMER® 100 P by the BASF company.

C) Copolymers derived from crotonic acid such as those comprising in their chain vinyl acetate or propionate units and optionally other monomers such as allyl, methallyl or vinyl esters of a linear or branched, hydrocarbon long-chain, saturated carboxylic acid comprising at least 5 carbon atoms, where these polymers may be optionally graft and crosslinked, or vinyl, allyl or methallyl esters of a carboxylic α- or β-cyclic acid.

Such polymers are described, amongst others, in the French patent Application Nos. FR 1 222 944, FR 1 580 545, FR2 265 782, FR 2 265 781, FR 1 564 110 and FR 2 439 798.

As suitable examples of commercial products belonging to this class, the 28-29-30, 26-13-14 and 28-13-10 resins may be mentioned, which are marketed by the NATIONAL STARCH company and MEXOMERE PW available from the CHIMEX company.

D) Copolymers derived from monounsaturated C₄-C₈ carboxylic acids or anhydrides selected from:
copolymers comprising:
(ii) at least one acid and/or anhydride chosen from maleic, fumaric, itaconic acid and/or anhydride and
(iii) at least one monomer selected from vinyl esters, vinyl ethers, vinyl halides, phenylvinyl derivatives, acrylic acid and esters thereof, the anhydride functional groups of these copolymers being optionally monoesterified or monoamidified.

Such polymers are described in U.S. Pat. Nos. 2,047,398; 2,723,248; 2,102,113 and GB 839,805, including those marketed under the trade names GANTREZ AN or ES, AVANTAGE® CP by the ISP company;
copolymers comprising (i) at least one maleic, citraconic or itaconic anhydride and (ii) at least one monomer selected from allyl or methallyl esters optionally comprising in their chain at least one acrylamide, methacrylamide, α-olefin, acryl or methacryl esters, acrylic or methacrylic acids or vinyl pyrrolidone groups, the anhydride functional groups of these copolymers being optionally monoesterified or monoamidified.

These polymers are for example described in the French patent applications FR 2 350 384 and FR 2 357 241.

E) Polyacrylamides comprising carboxylate groups.

F) Branched acrylic block copolymers. In this family, by way of non-limiting example, mention can be made of branched block copolymers comprising as main monomers at least one C₁-C₂₀ alkyl acrylate and/or at least one N mono- or N,N di-(C₂-C₁₂ alkyl)(meth)acrylamide and acrylic acid and/or methacrylic acid. These fixing polymers may be branched block copolymers with a structure comprising hydrophobic blocks to which they are bound, for instance through bifunctional units, with a certain amount of more hydrophilic blocks. These copolymers have at least two glass transition temperatures.

For instance they are described in Patent No. WO 00/40628.

Branched block copolymers described hereabove are available for example under the trade names EX-SDR-26® and EX-SDR-45® from the GOODRICH company, and EX-SDR-752 (FIXATE G100L from NOVEON).

These copolymers typically have the following composition:

Acrylic acid from 26 to 36 mole percent

N-butyl acrylate from 27.5 to 30.5 mole percent

Methacrylic acid from 33.3 to 45.3 mole percent

Allyl methacrylate from 0.48 to 0.92 mole percent.

The most hydrophobic blocks have a molecular weight from 10,000 to 100,000 Daltons and the most hydrophilic blocks have a molecular weight of 1,000 to 100,000 Daltons.

The anionic groups of the anionic fixing polymers of the present disclosure may also be sulfonic acid groups carried by vinyl sulfonic, styrene sulfonic, naphthalene sulfonic or acrylamidoalkyl sulfonic units.

These sulfonic acid group-containing polymers can be chosen from:
poly(vinyl sulfonic acid) salts having a weight average molecular weight ranging from about 1,000 to 100,000 as well as copolymers of vinyl sulfonic acid and an unsaturated comonomer such as acrylic acid, methacrylic acid, esters of these acids, acrylamide, acrylamide derivatives, vinyl ethers and vinyl pyrrolidone;
poly(styrene sulfonic acid) salts. Suitable examples thereof include two sodium salts having a weight average molecular weight ranging from 50,000 to 100,000, marketed respectively under the trade names FLEXAN® 500 and FLEXAN® 130 by the NATIONAL STARCH company. These compounds are described in the French Patent No. FR 2 198 719;
poly(acrylamide sulfonic acid) salts, such as those mentioned in U.S. Pat. No. 4,128,631, for example, the poly(acrylamidoethyl propanesulfonic acid) salt marketed under the trade name COSMEDIA POLYMER® HSP 1180 by the HENKEL company; and
linear sulfonic polyesters.

As used herein, a “sulfonic polyester” is understood to mean copolyesters obtained by polycondensing at least one dicarboxylic acid or an ester thereof, at least one diol and at least one sulfoaryl dicarboxylic bifunctional compound substituted on the aromatic ring with a —SO₃M group, wherein M is a hydrogen atom or a metal ion such as Na+, Li+ or K+.

Water-dispersible linear sulfonic polyesters typically have a weight average molecular weight ranging from 1,000 to 60,000, and further, for example, from 4,000 to 20,000, as determined by gel-permeation chromatography (GPC).

The glass transition temperature (Tg) for these sulfonic polyesters is typically ranges from 10° C. to 100° C. According to at least one embodiment, the Tg for the used polyester(s) is higher than or equal to 50° C.

The glass transition temperature (Tg) is measured by a differential scanning calorimetry (DSC) according to the ASTM D3418-97 standard.

They are described in more detail in U.S. Pat. Nos. 3,34,874; 3,779,993; 4,119,680; 4,300,580; 4,973,656; 5,60,816; 5,662,893; and 5,674,479.

The sulfonic polyesters that may be used in the present disclosure comprise at least units derived from isophthalic acid, sulfoaryl dicarboxylic acid and diethylene glycol salt, and further, for example, the sulfonic polyesters used in the present disclosure are obtained from isophthalic acid, sulfoisophthalic acid, sodium salt, diethylene glycol and 1,4-cyclohexanemethanol.

Suitable examples of sulfonic polyesters include but are not limited to those known under the INCI name Diglycol/CHDM/Isophtalates/SIP, and sold under the trade names “Eastman AQ polymer” (AQ35S, AQ38S, AQ55S, AQ48 Ultra) by the Eastman Chemical company.

According to at least one embodiment, the Tg for the used polyester(s) is higher than or equal to 50° C.

As disclosed herein, the anionic polymers can be chosen from acrylic acid-based copolymers, such as the terpolymer of acrylic acid, ethyl acrylate and N-tertbutyl acrylamide marketed under the trade name ULTRAHOLD STRONG® by the BASF company, copolymers derived from crotonic acid such as terpolymers of vinyl acetate, vinyl p-tert-butylbenzoate and crotonic acid (MEXOMERE PW from the CHIMEX company) and terpolymers of crotonic acid, vinyl acetate and vinyl neododecanoate marketed under the trade name Resin 28-29-30 by the NATIONAL STARCH company, polymers derived from maleic, fumaric, itaconic acids or anhydrides with vinyl esters, vinyl ethers, vinyl halides, phenylvinyl derivatives, acrylic acid and esters thereof such as the copolymer of methylvinyl ether and monoesterified maleic anhydride marketed under the trade name GANTREZ® ES 425 by the ISP company, the copolymer of methacrylic acid and ethyl acrylate marketed under the trade name LUVIMER® MAEX by the BASF company, the terpolymer of vinyl pyrrolidone, acrylic acid, laurylalkyl methacrylate sold by the ISP company under the trade name ACRYLIDONE LM and the copolymer of vinyl acetate and crotonic acid marketed under the trade name LUVISET® CA 66 by the BASF company and the terpolymer of vinyl acetate, crotonic acid and polyethylene glycol marketed under the trade name ARISTOFLEX® A by the BASF company, the linear sulfonic polyesters, such as AQ55S from the EASTMAN company, branched acrylic block copolymers, for instance FIXATE G100L from the NOVEON company.

Amphoteric fixing polymers to be suitably used according to the present disclosure can be chosen from polymers comprising B and C units randomly distributed within the polymer chain, where B is a unit derived from a monomer comprising at least one basic nitrogen atom and C is a unit derived from a monomer comprising at least one carboxylic acid or sulfonic acid group. Amphoteric fixing polymers may also comprise zwitterionic units of the carboxybetaine or sulfobetaine type. They also may be polymers with a cationic main chain comprising primary, secondary, tertiary or quaternary amine groups, amongst which at least one carries through a hydrocarbon radical, a carboxylic acid or sulfonic acid group. Amphoteric fixing polymers may further have an anionic-type chain derived from unsaturated α,β-dicarboxylic acids, one carbonyl group of which has been reacted with a polyamine comprising at least one amine chosen from primary and secondary amine groups.

Amphoteric fixing polymers as disclosed herein can be chosen from, by way of non-limiting the following polymers:
(1) polymers resulting from the copolymerization of a vinyl monomer carrying a carboxylic acid group such as acrylic acid, methacrylic acid, maleic acid, α-chloroacrylic acid and of a vinyl monomer comprising at least one basic function such as dialkylaminoalkyl methacrylate and acrylate or dialkylaminoalkyl (meth)acrylamides. Such compounds are described, for example, in the U.S. Pat. No. 3,836,537.
(2) Polymers comprising units derived from:
   (a) at least one monomer selected from N-alkylated acrylamides or methacrylamides,
   (b) at least one comonomer comprising at least one carboxylic acid functional group, and
   (c) at least one basic comonomer such as acrylic acid and methacrylic acid esters with primary, secondary, tertiary or quaternary amine substituents and the quaternization product from dimethylaminoethyl methacrylate with dimethyl or diethyl sulfate.

According to at least one embodiment, N-alkylated acrylamides or methacrylamides (a) are those carrying C₂₋₁₂ alkyl radicals, such as N-ethyl acrylamide, N-tertbutyl acrylamide, N-tert-octyl acrylamide, N-octyl acrylamide, N-decyl acrylamide, N-dodecyl acrylamide, as well as corresponding methacrylamides.

Carboxylic acid group-containing comonomers (b) can be chosen from acrylic, methacrylic, crotonic, itaconic, maleic and fumaric acids as well as from maleic or fumaric acid or anhydride C₁₋₄ alkyl monoesters.

According to at least one embodiment, basic comonomers (c) are aminoethyl methacrylate, butylaminoethyl methacrylate, N,N′-dimethylaminoethyl methacrylate and N-tertbutylaminoethyl methacrylate.

Copolymers which CTFA name (4th Ed., 1991) corresponds to “Octyl acrylamide/acrylates/butylaminoethylmethacrylate copolymer” may be used, such as the products marketed under the trade name AMPHOMER® or LOVOCRYL® 47 by the NATIONAL STARCH company.

(3) Crosslinked and alkylated polyaminoamides, derived for the whole or part of them from polyaminoamides having following general formula:

—[C(=0)—R₄—C(=0)-Z-]- (II)

wherein R₄ is a divalent radical derived from a saturated dicarboxylic acid, an ethylene double bond mono- or dicarboxylic aliphatic acid, a C₁₋₆ alkyl ester of these acids or a radical resulting from adding any amongst said acids to a bis-primary or bis-secondary amine, and Z is a bis-primary, mono- or bis-secondary polyalkylene polyamine radical, and according to at least one embodiment represents:

a) in amounts ranging from 60 to 100 mole percent, the radical:

—NH—[(CH₂)ₓ—NH]ₚ— (III)

wherein x=1 and p=2 or 3, or x=3 and p=2,
this radical being derived from diethylene triamine, triethylene tetraamine or dipropylene triamine;

b) in amounts ranging from 0 to 40 mole percent, the radical of formula (III) wherein x=2 and p=1, derived from ethylene diamine, or the radical

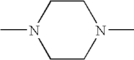

derived from piperazine:

c) in amounts ranging from 0 to 20 mole percent, the —NH—(CH₂)₆—NH— radical derived from hexamethylene diamine, these polyaminoamines being crosslinked by adding from 0.025 to 0.35 mole per amine group mole, of a bifunctional crosslinking agent selected from epihalohydrines, diepoxides, dianhydrides, di-unsaturated compounds which are alkylated with acrylic acid, chloroacetic acid or an alkane-sulfone.

As disclosed herein, the saturated carboxylic acids can be chosen from acids having from 6 to 10 carbon atoms such as adipic acid, trimethyl-2,2-4-adipic acid and trimethyl-2,4,4-adipic acid, terephthalic acid, ethylene double bond acids as, for example, acrylic, methacrylic, and itaconic acids.

The alkane-sulfones used in the alkylation, according to at least one embodiment, are propanesulfone or butanesulfone.

The alkylating agent salts, according to another embodiment, are the sodium or potassium salts.

(4) Polymers comprising zwitterionic units of formula (IV):

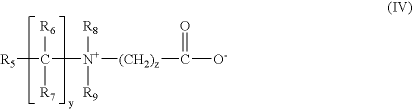

wherein:
R₅ is an unsaturated polymerizable group such as an acrylate, methacrylate, acrylamide or methacrylamide group,
y and z are each an integer ranging from 1 to 3,
R₆ and R₇ are each independently chosen from a hydrogen atom or a methyl, ethyl and propyl group,
R₈ and R₉ are each independently chosen from a hydrogen atom or an alkyl radical, where the total number of carbon atoms in R₈ and R₉ do not exceed 10.

Polymers which do comprise such units of formula (IV) may further comprise units derived from non zwitterionic monomers such as dimethyl or diethylaminoethyl acrylate or methacrylate, alkyl acrylates or methacrylates, vinyl acrylamides or methacrylamides or acetate.

As an illustration, the copolymer of methyl methacrylate and dimethylcarboxymethyl ammonioethyl methacrylate may be mentioned, such as the product marketed under the trade name DIAFORMER® Z301 by the SANDOZ company.

(5) Polymers derived from chitosan comprising monomer units having following formulae:

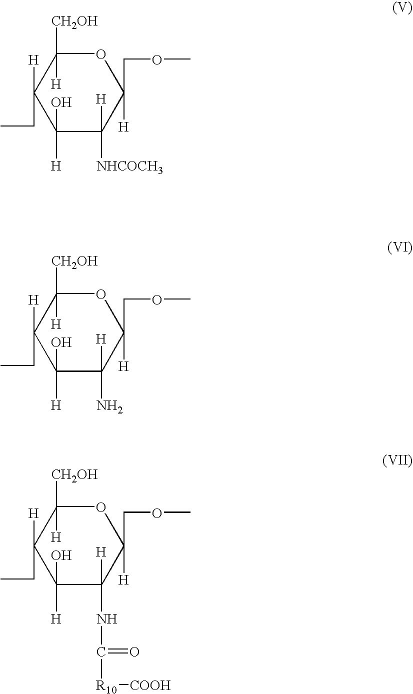

where the unit of formula (V) is present in an amount ranging from 0 to 30%, the unit of formula (VI) in an amount ranging from 5 to 50%, and the unit of formula (VII) in an amount ranging from 30 to 90%, being understood that in this unit (VII), R₁₀ is a radical of formula:

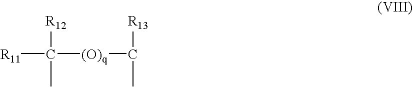

wherein:

if q=0, then R₁₁, R₁₂ and R₁₃, being the same or different, are each chosen from a hydrogen atom, a methyl, hydroxyl, acetoxy or amino group, a monoalkyl amine or dialkyl amine group optionally interrupted by at least one nitrogen atom and/or optionally substituted with at least one amine, hydroxyl, carboxyl, alkylthio, and sulfo group, an alkylthio group, the alkyl group of which carries an amino residue, at least one of the radicals R₁₁, R₁₂ and R₁₃ being in that case a hydrogen atom;

or

if q=1, then R₁₁, R₁₂ and R₁₃ are each a hydrogen atom, as well as salts formed by these compounds with bases or acids.

6) Polymers obtained by N-carboxyalkylation of chitosan, such as N-carboxymethylchitosan or N-carboxybutylchitosan marketed under the trade name EVALSAN® by the JAN DEKKER company.

(7) Polymers having general formula (IX):

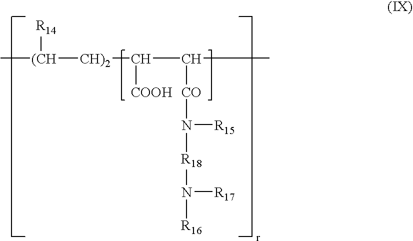

for example, those in the French Patent Application No. FR 1 400 366, wherein:

R₁₄ is a hydrogen atom or a CH₃O, CH₃CH₂O or phenyl radical,

R₁₅ is a hydrogen atom or a lower alkyl radical such as a methyl or ethyl radical,

R₁₆ is a hydrogen atom or a lower alkyl radical such as a methyl or ethyl radical,

R₁₇ is a lower alkyl radical such as a methyl or ethyl radical or a radical having following formula:

—R₁₈—N(R₁₆)₂,

wherein

R₁₈ represents a —CH₂—CH₂—, —CH₂—CH₂—CH₂—, —CH₂—CH(CH₃)— group, and

R₁₆ being such as previously defined, as well as higher homologues of these radicals comprising up to 6 carbon atoms.

(8) Amphoteric polymers of the -D-X-D-X- type selected from:
(a) polymers obtained by reacting chloroacetic acid or sodium chloroacetate with compounds comprising at least one unit of formula:

-D-X-D-X-D- (X)

wherein D is a radical:

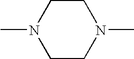

and where X is the E or E′ symbol, E or E′ being the same or different and representing a divalent radical which is a straight- or branched-chain alkylene radical comprising up to 7 carbon atoms in the main chain non substituted or substituted with hydroxyl groups and which may further comprise oxygen, nitrogen or sulfur atoms, from 1 to 3 aromatic and/or heterocyclic ring(s), oxygen, nitrogen or sulfur atoms being present as ether, thioether, sulfoxide, sulfone, sulfonium, alkyl amine, alkenyl amine groups, hydroxyl, benzyl amine, amine oxide, quaternary ammonium, amide, imide, alcohol, ester and/or urethane groups.
b) Polymers of formula:

-D-X′-D-X′— (X′)

wherein D is a radical

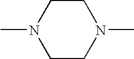

and where X′ is the E or E′ symbol and at least one time E′, E being such as defined hereabove and E′ being a divalent radical which is a straight- or branched-chain alkylene radical having up to 7 carbon atoms in the main chain, substituted or not by at least one hydroxyl radical and comprising at least one nitrogen atom, said nitrogen atom being substituted by an alkyl chain optionally interrupted by an oxygen atom and compulsorily comprising at least one carboxyl functional group or at least one hydroxyl functional group and betainized by reacting with chloroacetic acid or sodium chloroacetate.

9) Copolymers of (C₁₋₅)alkyl vinyl ether and maleic anhydride partly modified by half-amidification with a N,N-dialkylaminoalkyl amine such as N,N-dimethylaminopropyl amine, or half-esterification with a N,N-dialkanol amine. These copolymers may also comprise other vinyl comonomers such as vinyl caprolactame.

According to at least one embodiment, the amphoteric fixing polymers include those of family (3) as disclosed herein, such as those which CTFA name corresponds to “Octylacrylamide/acrylates/butylaminoethyl-methacrylate copolymer”. To be mentioned as suitable examples thereof are the products marketed under the trade names AMPHOMER®, AMPHOMER® LV 71 or LOVOCRYL® 47 by the NATIONAL STARCH company.

According to another embodiment, amphoteric fixing polymers are those of family (4), as for example copolymers of methyl methacrylate and dimethylcarboxymethyl ammonioethyl methacrylate, marketed for example under the trade name DIAFORMER® Z301 by the SANDOZ company.

The anionic or amphoteric fixing polymers may, if necessary, be partly or fully neutralized. Neutralizing agents include, for example, soda, potash, amino-2-methyl propanol, monoethanolamine, triethanolamine or tri-isopropanolamine, mineral or organic acids such as hydrochloric acid or citric acid.

The non ionic fixing polymers to be used according to the present disclosure are chosen, for example from:
vinyl pyrrolidone homopolymers,
copolymers of vinyl pyrrolidone and vinyl acetate,
polyalkyl oxazolines such as polyethyl oxazolines available from the DOW CHEMICAL company under the trade names PEOX® 50 000, PEOX® 200 000 and PEOX® 500 000,
vinyl acetate homopolymers such as the product available under the trade name APPRETAN® μM by the HOECHST company or the product available under the trade name RHODOPAS® A 012 by the RHONE POULENC company;
copolymers of vinyl acetate and acrylesters such as the product available under the trade name RHODOPAS® AD 310 from RHONE POULENC,
copolymers of vinyl acetate and ethylene such as the product available under the trade name APPRETAN® TV from the HOECHST company,
copolymers of vinyl acetate and maleic ester, for example of dibutyl maleate such as the product available under the trade name APPRETAN® MB EXTRA from the HOECHST company,
copolymers of ethylene and maleic anhydride,
alkyl acrylate homopolymers and alkyl methacrylate homopolymers such as the product available under the trade name MICROPEARL® RQ 750 from the MATSUMOTO company or the product available under the trade name LUHYDRAN® A 848 S from the BASF company,
copolymers of acrylic esters, such as for example copolymers of alkyl acrylates and alkyl methacrylates such as the products available from the ROHM & HAAS company under the trade names PRIMAL AC-261 K and EUDRAGIT NE 30 D, from the BASF company under the trade names ACRONAL® 601, LUHYDRAN® LR 8833 or 8845, and from the HOECHST company under the trade names APPRETAN® N 9213 or N 9212,
copolymers of acrylonitrile and a non ionic monomer selected for example from butadiene and alkyl (meth)acrylates; to be mentioned are for example the products available under the trade names NIPOL® LX 531 B from the NIPPON ZEON company or those available under the trade name CJ 0610 B from the ROHM & HAAS company,
polyurethanes such as the products available under the trade names ACRYSOL® RM 1020 or ACRYSOL® RM 2020 from the ROHM & HAAS company, the products URAFLEX® XP 401 UZ, URAFLEX® XP and 402 UZ from the DSM RESINS company,
copolymers of alkyl acrylate and urethane such as the product 8538-33 marketed by the NATIONAL STARCH company,
polyamides such as the product ESTAPOR® LO 11 available from the RHONE POULENC company,
chemically modified, or not, non ionic guar gums.

Non modified, non ionic guar gums that can be used according to the present disclosure include, for example, the products marketed under the trade name VIDOGUM® GH 175 by the UNIPECTINE company and under the trade name JAGUAR® C by the MEYHALL company. Modified non ionic guar gums to be suitably used in the present disclosure have been modified with C₁₋₈ hydroxyalkyl groups. Suitable non-limiting examples include hydroxymethyl, hydroxyethyl, hydroxypropyl and hydroxybutyl groups.

These guar gums are well-known in the art and may be prepared, for example, by reacting corresponding alkene oxides, such as for example propylene oxides with the guar gum so as to obtain a guar gum that has been modified with hydroxypropyl groups.

Such non ionic guar gums, that have been optionally modified with hydroxyalkyl groups are sold, for example, under the trade names JAGUAR® HP8, JAGUAR® HP60 and JAGUAR® HP120, JAGUAR® DC 293 and JAGUAR® HP 105 by the MEYHALL company, or under the trade name GALACTASOL® 4H4FD2 by the AQUALON company.

According to the present disclosure, to be suitably used as fixing polymers, are also film-forming polymers of the graft silicone type, comprising one polysiloxane part and one part made of a non silicone organic chain, one of the two parts forming the polymer main chain and the other being graft onto said main chain.

These polymers are for example described in the Patent Application Nos. EP-A-0 412 704, EP-A-0 412 707, EP-A-0 640 105 and WO 95/00578, EP-A-0582 152 and WO 93/23009 and U.S. Pat. Nos. 4,693,935; 4,728,571; and 4,972,037.

According to at least one embodiment, these polymers are anionic or non ionic in nature.

Such polymers are, for example, copolymers that might be obtained by a free-radical polymerization from a mixture of monomers comprising,

a) from 50 to 90% by weight of tertbutyl acrylate,

b) from 0 to 40% by weight of acrylic acid,

c) from 5 to 40% by weight of a silicone-based macromer of following formula:

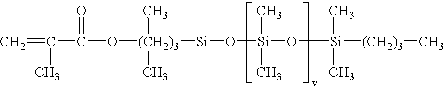

wherein v is a number ranging from 5 to 700, percentages by weight being expressed as related to the monomer total weight.

Other examples of graft silicone polymers include but are not limited to polydimethyl siloxanes (PDMS) onto which mixed polymer units of the poly(meth)acrylic acid and alkyl poly(meth)acrylate type are graft through a thiopropylene type chain member, and polydimethyl siloxanes (PDMS) onto which polymer units of the isobutyl poly(meth)acrylate type are graft through a thiopropylene type chain member.

Functionalized or not, silicone or non silicone polyurethanes may also be used as fixing polymers.

Polyurethanes that can be used according to the present disclosure are those described in the European Patent Application Nos. EP 0 751 162, EP 0 637 600, FR 2 743 297 and EP 0 648 485 in the name of the Applicant, as well as in Application Nos. EP 0 656 021 or WO 94/03510 in the name of BASF company and EP 0 619 111 in the name of NATIONAL STARCH company.

A suitable example of a non silicone fixing polyurethane is the LUVISET PUR polymer available from the BASF company. A suitable example of silicone fixing polyurethane is the LUVISET Si PUR polymer, also available from the BASF company.

The fixing polymer can be chosen from silicone or non silicone polyurethanes, linear sulfonic polyesters, branched acrylic block copolymers, and copolymers of octyl acrylamide, acrylates and butylaminoethyl methacrylates.

Thus, the fixing polymers may be chosen from AMPHOMER from NATIONAL STARCH, LUVISET Si Pur from BASF, FIXATE G100 from NOVEON, MEXOMERE PW from CHIMEX, and AQ 55S from EASTMAN.

According to at least one embodiment, the at least one fixing polymer is present in an amount ranging from 0.1 to 20% by weight, for example from 1 to 12% by weight, relative to the total weight of the cosmetic composition.

The compositions may further comprise at least one hair fiber protecting agent.

The at least one hair fiber protecting agent may be any active agent efficient for preventing or limiting any hair damaging that would result from physical or chemical stress.

Thus, the at least one hair fiber protecting agent may be chosen from organic water-soluble, fat-soluble UV radiation-filtering systems, anti-free radical agents, antioxidants, vitamins, provitamins, vegetable waxes, ceramides, and proteins.

Organic UV radiation-filtering systems can be chosen from water-soluble or fat-soluble, silicone or non silicone filters and mineral oxide nanoparticles, the surface of which has optionally been treated so as to become hydrophilic or hydrophobic.

Organic water-soluble UV radiation-filtering systems may be chosen from, for example, para-aminobenzoic acid and salts thereof, anthranilic acid and salts thereof, salicylic acid and salts thereof, p-hydroxycinnamic acid and salts thereof, benz-x-azole sulfonic derivatives (benzothioazoles, benzimidazoles, benzoxazoles) and their salts, benzophenone sulfonic derivatives and their salts, benzylidene camphor sulfonic derivatives and their salts, benzylidene camphor derivatives substituted with a quaternary amine and their salts, phthalydene-camphosulfonic acid derivatives and their salts, benzotriazole sulfonic derivatives.

Hydrophilic polymers may also be used, which have, in addition to and because of their chemical nature, UV radiation-photoprotecting properties. By way of example, polymers comprising benzylidene camphor and/or benzotriazole groups, substituted with sulfonic or quaternary ammonium groups may be mentioned.

Organic fat-soluble (or lipophilic) UV radiation-filtering systems that can be suitably implemented in the present disclosure include but are not limited to p-aminobenzoic acid derivatives, such as p-aminobenzoic acid esters or amides; salicylic acid derivatives such as esters; benzophenone derivatives; dibenzoylmethane derivatives; diphenyl acrylate derivatives; benzofurane derivatives; polymer-based UV radiation-filtering systems comprising at least one silico-organic residue; cinnamic acid esters; camphor derivatives; trianilino-s-triazine derivatives; urocanic acid ethyl ester; benzotriazoles; hydroxyphenyl triazine derivatives; bis-resorcinol dialkylaminotriazines; and mixtures thereof.

The fat-soluble (or lipophilic) UV filter according to the present disclosure may be chosen from octyl salicylate; 4-tertbutyl 4′-methoxydibenzoylmethane (PARSOL 1789 from GIVAUDAN); octocrylene; 2-ethylhexyl 4-methoxy cinnamate (PARSOL MCX) and the compound of following formula (XIII), or 2-(2H-benzotriazole-2-yl)-4-methyl-6-[2-methyl-3-[1,3,3,3-tetramethyl-1-[(trimethylsilyl)oxy]disiloxanyl]propynyl]phenol, described in the European Patent Application No. EP-A-0 392 883:

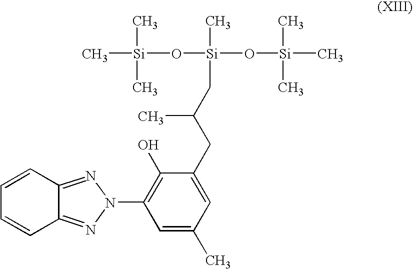

Other UV radiation-filtering systems that may be used according to the present disclosure include benzophenone derivatives such as UVINUL MS 40 (2-hydroxy 4-methoxybenzophenone-5-sulfonic acid) and UVINUL M40 (2-hydroxy-4-methoxybenzophenone) marketed by BASF, benzalmalonate derivatives such as PARSOL SLX (polydimethyl/methyl (3(4-(2,2-bis-ethoxycarbonylvinyl)-phenoxy)-propenyl) siloxane) marketed by GIVAUDAN-ROURE, benzylidene-camphor derivatives such as MEXORYL SX (b-b′camphosulfonic acid [1-4 divinyl benzene]) made by the CHIMEX company, benzimidazole derivatives such as EUSOLEX 232 (2-phenyl-benzimidazol-5-sulfonic acid) marketed by MERCK.

The pH value may be adjusted to the expected level by using acidifying or alkalinizing agents that are well-known from the state of the art.

Suitable alkalinizing agents include for example ammonia, alkaline carbonates, alkanolamines such as mono-, di- and triethanolamines as well as their derivatives, oxyethylenated and/or oxypropylenated hydroxyalkyl amines and ethylene diamines, sodium or potassium hydroxides and compounds of following formula:

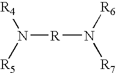

wherein:

R is a propylene residue optionally substituted by a hydroxyl group or a C₁-C₄ alkyl radical;

R₄, R₅, R₆ and R₇, being the same or different, are chosen from a hydrogen atom, a C₁-C₄ alkyl radical, and a C₁-C₄ hydroxyalkyl radical.

According to at least one embodiment, a triethanol amine is used as an alkalinizing agent in the compositions of the present disclosure.

Traditionally, the acidifying agents are mineral or organic acids such as hydrochloric acid, orthophosphoric acid, carboxylic acids such as tartaric acid, citric acid, lactic acid or sulfonic acids.

Direct dyes may also be incorporated into the compositions of the present disclosure.

Non-limiting examples of direct dyes to be suitably used in the present disclosure include neutral, acidic or cationic nitrobenzene direct dyes, neutral, acidic or cationic azo direct dyes, quinone direct dyes, including but not limited to neutral, acidic or cationic anthraquinone direct dyes, azine direct dyes, triarylmethane direct dyes, indoamine direct dyes and natural direct dyes.

Preserving agents or anticorrosive agents may also be incorporated into the cosmetic compositions of the present disclosure.

Amongst the preserving agents, sorbic acid and salts thereof, parahydroxybenzoic acid esters and phenoxyethanol may be mentioned.

Amongst the anticorrosive agents to be suitably used in the present disclosure, cyclohexyl amine, diammonium phosphate, dilithium oxalate, dimethylamino methylpropanol, dipotassium oxalate, dipotassium phosphate, disodium phosphate, disodium pyrophosphate, disodium tetrapropenyl succinate, hexoxyethyl diethylammonium phosphate, nitromethane, potassium silicate, sodium aluminate, sodium hexametaphosphate, sodium metasilicate, sodium molybdate, sodium nitrite, sodium oxalate, sodium silicate, stearamidopropyl dimethicone, tetrapotassium pyrophosphate and triisopropanolamine may be mentioned, for example.

According to at least one embodiment, the cosmetic composition described hereabove further comprises a compound selected from fixing polymers, alkalinizing agents, acidifying agents, organic solvents, fragrances, preserving agents, UV radiation-absorbing agents, coloring agents, anticorrosive agents, and mixtures thereof.

The cosmetic composition according to the present disclosure may further comprise water.

The cosmetically acceptable medium of the composition according to the present disclosure may further comprise at least one organic solvent.

As used herein, an “organic solvent” is understood to mean an organic compound which is in the liquid state at a temperature of 25° C. and at the atmospheric pressure (760 mm mercury (Hg)).

The organic solvent of the cosmetic composition is typically chosen from C₁-C₆ alcohols, for instance from alkanols such as ethanol, propanol and isopropanol, polyols such as glycerol, propylene glycol and pentanediol, benzyl alcohol, and mixtures thereof.

According to at least one embodiment, the organic solvent is ethanol.

In general, when present, said organic solvent is present in an amount ranging from 1 to 98%, for example from 20 to 95% by weight, relative to the total weight of the composition.

The spraying device for a composition according to the present disclosure may be used for non rinsed-off applications, either on dry hair or on wet hair.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in its respective testing measurement.

The following examples illustrate the present disclosure in a non-limiting manner.

### EXAMPLES

### Examples of Formulation

### Example 1

Composition 1

| | | |
|---|---|---|
| Polyphenyl methylsiloxane marketed by DOW | 10.00 | g |
| CORNING under the trade name DOW CORNING | | |
| 556 COSMETIC GRAD FLUID | | |
| Ethylhexyl methoxycinnamate marketed by | 0.05 | g |
| ROCHE VITAMINS under the trade name PARSOL | | |
| MCX | | |
| Fragrance | 0.10 | g |
| Ethyl alcohol, absolute qs | 100 | g |

The Composition 1 was conditioned in a spraying device such as defined hereabove. Such device comprised a membrane which in turn comprised perforations having a cross-sectional area in the form of a circular plate which diameter ranged from 4 to 150 μm on the outer surface of the membrane facing the external environment, and on the inner surface facing the inside of the container, a cross-sectional area in the form of a circular plate which diameter ranged from 2 to 50 μm. Such device comprised a piezoelectric actuator able to make the membrane vibrate as well as an electric cell intended to supply the piezoelectric actuator with the necessary energy. The perforations in the device had a reverse taper.

When the device was used, the cosmetic composition was dispensed as droplets with a mean diameter ranging from 20 to 100 μm.

### Example 2

Composition 2

| | |
|---|---|
| Isopropyl myristate | 4.00 g |
| Petrolatum oil | 4.00 g |
| Ethylhexyl methoxycinnamate marketed by ROCHE | 0.05 g |
| VITAMINS under the trade name PARSOL MCX | |
| Fragrance | 0.10 g |
| Ethyl alcohol, absolute qs | 100 g |

The hereabove Composition 2 was conditioned in a spraying device similar to that described in Example 1.

The spraying device described in Example 1 and containing the composition of either 1 or 2, such as defined hereabove made it possible to obtain an intensive and/or long-lasting hair shine, which usually could not be obtained with the known devices without propellants such as pump-type dispenser bottles.

The application was carried out on wet hair and on dry hair.

What is claimed is:

1. A spraying device for a cosmetic composition comprising a container provided with a spraying mechanism comprising:
a perforated membrane, the membrane perforations making the container inner space communicate with the external environment,
an actuator for vibrating the membrane,
a mechanism for making the liquid cosmetic composition contained in the container contact an inner surface of the membrane,
wherein the cosmetic composition, under the effect of the membrane vibrations, flows through the perforations until reaching an outer surface of the membrane, from which it emerges as droplets, and
wherein said liquid cosmetic composition comprising, in a cosmetically acceptable medium, at least one silicone and/or at least one non silicone fatty substance.

2. The spraying device according to claim 1, wherein at least one of the perforations in the membrane has a reverse taper.

3. The spraying device according to claim 1, further comprising a pressure bias mechanism providing a reduced pressure to the liquid contacting the inner surface of the membrane.

4. The spraying device according to claim 3, wherein the reduced pressure varies from ambient pressure up to the pressure at which the air is sucked-in through the perforations of the membrane contacting the composition.

5. The spraying device according to claim 1, wherein the perforations arranged on the outer surface of the membrane do not contact each other.

6. The spraying device according to claim 1, wherein the actuator is a piezoelectric actuator.

7. The spraying device according to claim 1, wherein the mechanism for conveying the liquid cosmetic composition to the surface of the membrane comprises a capillary-based feeding mechanism.

8. The spraying device according to claim 1, wherein the mechanism for conveying the liquid cosmetic composition to the surface of the membrane comprises a bubble generator-based feeding mechanism.

9. The spraying device according to claim 1, wherein all the perforations have a reverse taper.

10. The spraying device according to claim 1, wherein the membrane further comprises at least one normally tapered perforation.

11. The spraying device according to claim 10, wherein the normally tapered perforations are arranged all around and on the outside of the perforations with reverse tapers.

12. The spraying device according to claim 1, wherein the actuator is designed to make the membrane vibrate within a frequency range from 20 KHz to 7 MHz.

13. The spraying device according to claim 1, wherein the at least one silicone is chosen from volatile, linear, cyclic, and aryl silicones.

14. The spraying device according to claim 13, wherein the at least one silicone is a phenyl trimethylsiloxy trisiloxane.

15. The spraying device according to claim 1, wherein the at least one silicone is present in an amount ranging from 0.1 to 40% by weight, relative to the total weight of the composition.

16. The spraying device according to claim 15, wherein the at least one silicone is present in an amount ranging from 1 to 20% by weight, relative to the total weight of the composition.

17. The spraying device according to claim 1, wherein the at least one non silicone fatty substance is chosen from fatty alcohols, fatty esters, mineral, vegetable, animal and synthetic oils, and waxes.

18. The spraying device according to claim 17, wherein the at least one fatty ester is chosen from ethyl, isopropyl, myristyl, cetyl, stearyl palmitates, ethyl-2-hexyl palmitate, 2-octyldecyl palmitate, alkyl myristates, isopropyl, butyl, cetyl, 2-octyldodecyl myristate, hexyl stearate, butyl stearate, isobutyl stearate; dioctyl malate, hexyl laurate, 2-hexyldecyl laurate, isononyl isononanoate, and cetyl octanoate.

19. The spraying device according to claim 1, wherein the at least one non silicone fatty substance is petrolatum oil.

20. The spraying device according to claim 1, wherein the at least one non silicone fatty substance is present in an amount ranging from 0.1 to 40% by weight, relative to the total weight of the cosmetic composition.

21. The spraying device according to claim 20, wherein the at least one non silicone fatty substance is present in an amount ranging from 1 to 20% by weight, relative to the total weight of the cosmetic composition.

22. The spraying device according to claim 1, wherein the cosmetic composition comprises water.

23. The spraying device according to claim 1, wherein said the cosmetic composition further comprises at least one adjuvant chosen from fixing polymers, alkalinizing agents, acidifying agents, fragrances, preserving agents, UV radiation-absorbing agents, coloring agents, and anticorrosive agents.

24. The spraying device according to claim 1, wherein the cosmetically acceptable medium comprises at least one organic solvent chosen from C₁-C₆ alcohols, polyols, and benzyl alcohol.
